(19) United States
(12) Patent Application Publication
(10) Pub. No.: US 2004/0027248 A1
(43) Pub. Date: Feb. 12, 2004

(54) Method and apparatus for identifying an alarm condition in a cooking apparatus

(76) Inventor: Lawrence Lile, Columbia, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/213,874

(22) Filed: Aug. 6, 2002

(51) Int. Cl. G08B 17/10

(52) U.S. Cl. 340/628

(57) ABSTRACT

A method and apparatus for a cooking appliance having a built-in smoke detector is disclosed. The disclosed apparatus includes a housing with a heating cavity, a door, a heating element, a controller, and a detection module. The detection module includes an energy source directing energy toward a first direction, and in communication with the controller, a detector unit receiving energy from a second direction substantially perpendicular to the first direction, and in communication with the controller, and an aperture for allowing entrance of air into the detection module from the cooking appliance, wherein the detector unit detects a level of smoke in the air from the cavity of the cooking appliance based on an amount of energy scattered from the first direction toward the second direction, and an alarm condition is identified based on the level of smoke. The disclosed method includes the steps of obtaining detection readings at predetermined intervals of time corresponding to an amount of scattered light in a detection module, comparing the obtained detection reading to a first smoke detection threshold and a second smoke detection threshold, determining whether an alarm condition exists based on said comparisons, and decreasing said intervals of time if an obtained detection reading is between said first and said second smoke detection thresholds.

### BACKGROUND OF THE INVENTION

1. Technical Field

The invention relates to cooking appliances, and more particularly, to a method and apparatus for identifying an alarm condition in an undercabinet cooking apparatus.

2. Related Art

Conventional cooking appliances such as ovens and toaster ovens, may present risk of smoke or fire if foods within the cooking cavities are overcooked. Such conditions may be more problematic in undercabinet cooking appliances due to their general placement in close proximity to wooden cabinets or other potentially flammable surfaces in a kitchen.

Undercabinet cooking appliances are desirable because of their significant space saving characteristic. Thus, a system to increase the safety of such undercabinet cooking appliances is needed. One such safety feature that may be added is a smoke detection means which, when smoke is detected, would deactivate the heating elements of the appliance and would further render the door to the cooking cavity inoperable. Such a system is particularly useful in a device which includes a door to the cooking cavity which automatically opens. Once a door is opened, increased oxygen and access to the foods can increase fire and/or smoke exposure to surrounding surfaces. If a safety system can operate in conjunction with the automatic door, preventing it from opening in an emergency, the safety of the appliance would be increased.

Photoelectric and ionization smoke detectors for the home are well known in the art and have been applied in cooking appliances in the past. However, these prior art devices have several disadvantages. First, many of these smoke detectors use light emitting diodes (LEDs) to illuminate smoke particles. LEDs provide energy having very precise characteristics such as wavelength and intensity. However, LEDs are expensive and require more power than other light sources, and often, the precise data LEDs may provide is not necessary. Further, certain foods which may be cooked in the cooking appliance emit acidic and/or greasy substances which may quickly corrode or otherwise damage or destroy the components in a conventional photoelectric or ionization smoke detector. This would substantially decrease the functional life of the smoke detection unit. Light-based prior art smoke detectors also experience diminished longevity due to stress put on their filaments when energized directly from a cooled, powered-off state to maximum intensity.

Finally, prior art cooking appliances often use a separate independent fan (or natural air convention) to force smoke through a smoke detection device. This adds to the complexity and expense of the cooking appliances especially those that already utilize a convection fan for added cooking efficiency. To decrease such cost and complexity, and to increase overall efficiency, it would be desirable to design the device such that a single fan is used for convection and smoke detection.

Thus, there is a need in the cooking art for an alarm system for use with cooking appliances to increase safety, while providing decreased complexity and cost, and lasting life.

### SUMMARY

These and other advances in the art are provided by the disclosed method and apparatus. The disclosed system may be embodied in various methods and apparatuses for a cooking appliance having a built-in smoke detector. A cooking appliance is disclosed comprising a housing with a heating cavity, a door, a heating element, a controller, and a detection module. The detection module includes an energy source directing energy toward a first direction, and in communication with the controller, a detector unit receiving energy from a second direction substantially perpendicular to the first direction, and in communication with the controller, and an aperture for allowing entrance of air into the detection module from the cooking appliance, wherein the detector unit detects a level of smoke in the air from the cavity of the cooking appliance based on an amount of energy scattered from the first direction toward the second direction, and an alarm condition is identified based on the level of smoke.

A method of detecting an alarm condition in a cooking appliance is also disclosed. The method comprises obtaining detection readings at predetermined intervals of time corresponding to an amount of scattered light in a detection module, comparing the obtained detection reading to a first smoke detection threshold and a second smoke detection threshold, determining whether an alarm condition exists based on said comparisons, and decreasing said intervals of time if an obtained detection reading is between said first and said second smoke detection thresholds.

Other systems, methods, features and advantages of the invention will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principals of the invention. Moreover, in the figures, like reference numerals designate corresponding parts throughout the different views.

FIG. 1 illustrates a perspective view of a cooking appliance to be located underneath a cabinet.

FIG. 2 illustrates a schematic diagram of a control system for the undercabinet cooking appliance of FIG. 1.

FIG. 3 illustrates a detailed schematic internal view of one side of the smoke detection module shown in FIG. 2.

FIG. 4 illustrates a complete smoke detection module with both sides of the module chamber securely sealed together to create a light-tight cavity within the smoke detection module.

FIG. 5 illustrates a general method of operation of the undercabinet cooking appliance illustrated in FIG. 1.

FIG. 6 illustrates a method of detecting smoke and alarm conditions in the undercabinet cooking appliance of FIG. 1.

FIG. 7 illustrates a side cutaway view of the cooking appliance illustrated in FIG. 1.

### DETAILED DESCRIPTION OF THE PREFERRED EMBODIMENTS

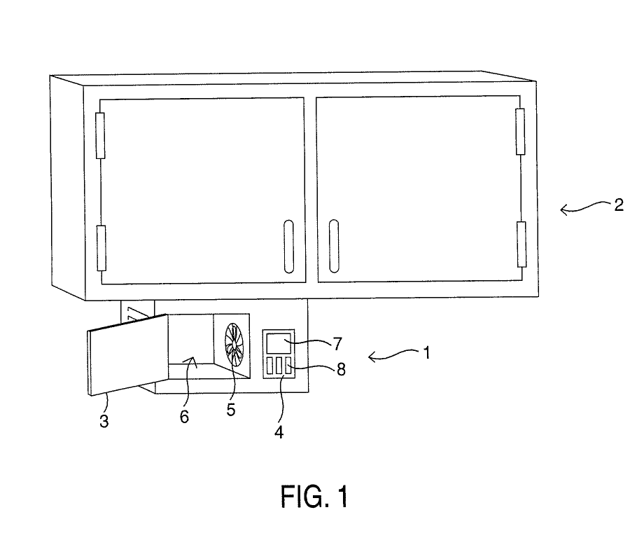

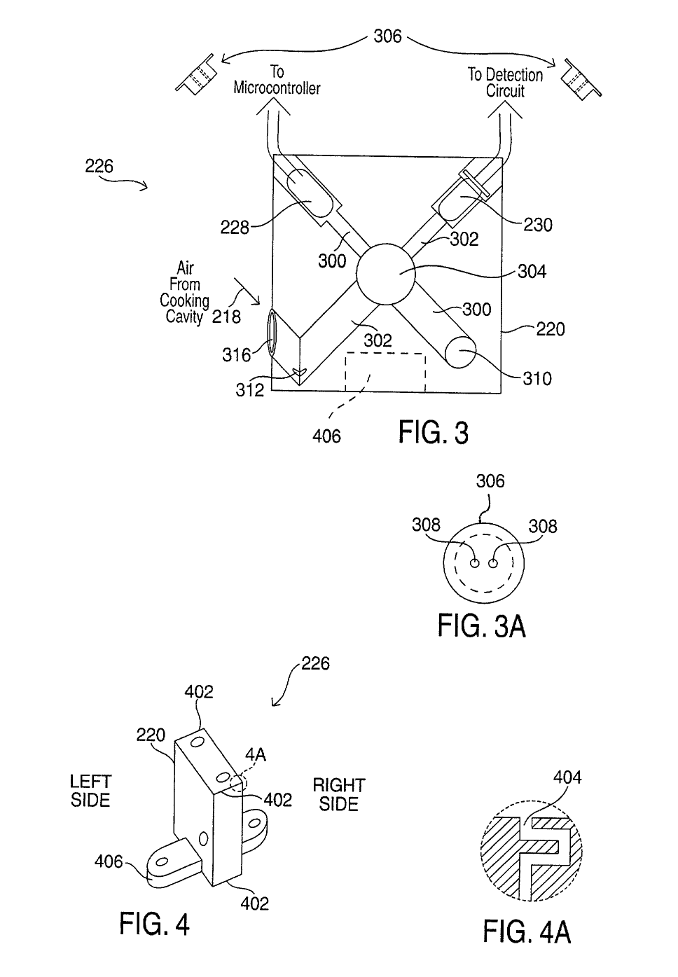

FIG. 1 illustrates a perspective view of the a cooking appliance 1 to be located underneath a cabinet 2 for space-saving purposes, also referred to as an “undercabinet” cooking appliance, in accordance with the invention. The illustrated appliance 1 allows a user to cook/heat a food item at a particular temperature or for a certain period of time, and includes a smoke detection module (“the smoke detection module” or “the module”) built into the controls of the cooking appliance 1. The smoke detection module (not shown in FIG. 1) is illustrated in detail in FIG. 3. The undercabinet cooking appliance 1 further includes an automatic door 3 (operation discussed further below), a user interface control panel 4, and a convection fan 5 inside the cooking cavity 6 for moving air within the cooking cavity 6 as well as from the cooking cavity 6 into the smoke detection module.

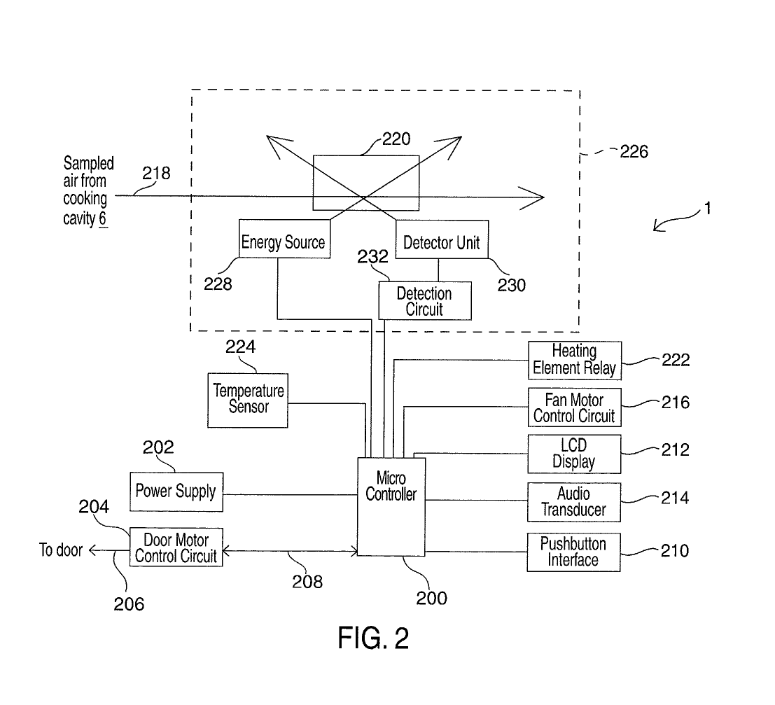

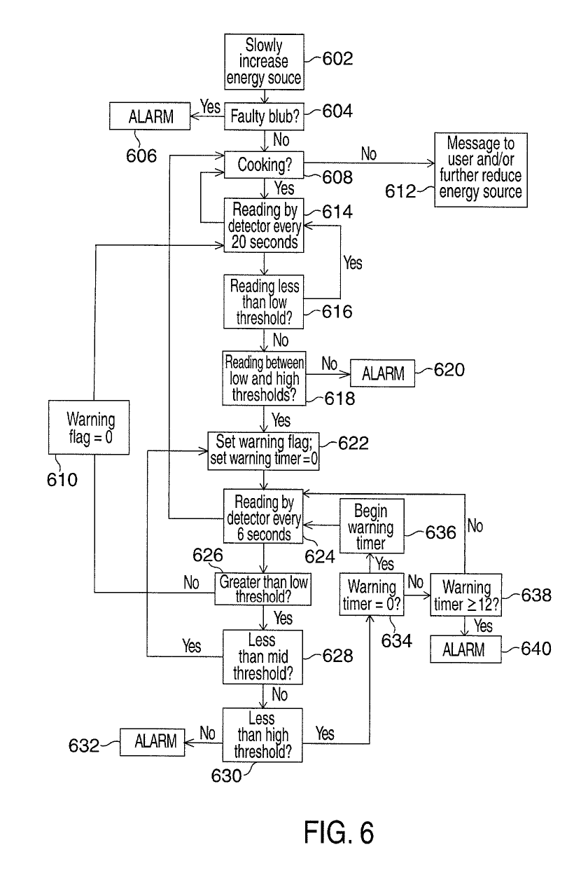

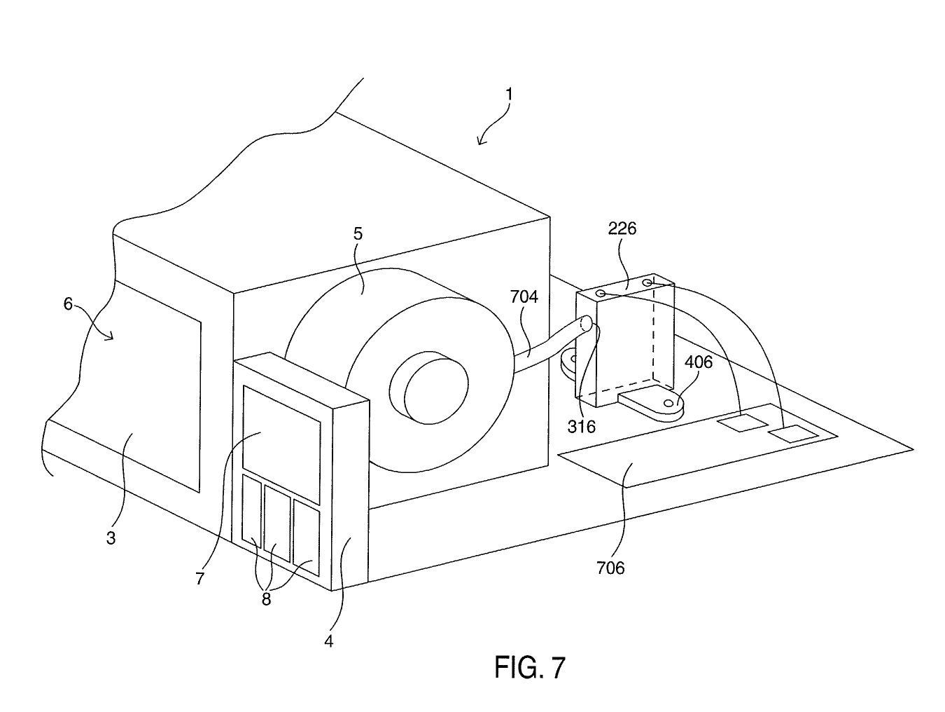

FIG. 2 illustrates a schematic diagram of the undercabinet cooking appliance 1 of FIG. 1. The disclosed undercabinet cooking appliance 1 includes a microcontroller or microprocessor 200 which contains control programs and peripherals to operate the overall appliance 1. The microcontroller may be, for example, a PIC16F73 chip manufactured by Microchip. A power supply 202, which supplies power to all circuits in appliance 1, is preferably a DC power supply which provides regulated DC power to the appliance 1. The undercabinet cooking appliance further includes a door motor control circuit 204 which provides a door signal 206 to the door 3 of the appliance instructing the door to open or close based on the amount of voltage applied to the door mechanism. The voltage is determined by instructions from the microcontroller 200. The door motor control circuit 204 further provides a door feedback signal 208 to the microcontroller 200 indicating the position of the door (e.g., open, closed) at any given time. This door position sensing task may be accomplished by position switches, optical sensors, or other means. The operation of the door 3 in accordance with the invention is described further with respect to FIGS. 5 and 6.

The appliance 1 further includes a user interface 210 operably associated with the user interface control panel 4 (FIG. 1) which allows a user to select various modes of operation of the appliance, such as for example, cooking times or temperatures. In addition, an LCD display 7 and/or other visual indicators or input buttons 8 may be included in the device to allow the user to input data (e.g., temperature, time, mode) and/or to show the user various information such as, for example, the status of the appliance 1, the cavity temperature, the current mode of operation, and/or an alarm condition (as described further herein). An audio transducer 214 (such as, for example, a PMK22 22 mm piezoelectric sounder from Panasonic) may also be included to indicate, for example, a button being pressed, a finished cooking cycle or an alarm condition.

The undercabinet cooking appliance 1 of the present invention preferably includes a fan motor control circuit 216 for controlling a convection fan 5 which moves air around the cooking cavity 6 thus increasing cooking efficiency. The convection fan may be preferably combined with a cooling fan which moves ambient air inside the oven but outside the cooking cavity, effectively cooling the controls and exhausting smoke particles which may have exited the smoke detection module. The convection fan 5 is also preferably used to force sampled air 218 from the cooking cavity 6 into the smoke detection chamber 220 of the smoke detection module 226. The smoke detection chamber 220 is preferably constructed such that no ambient light may enter the chamber 220. This characteristic is referred to herein as “light-tight.” To increase the light-tight characteristic, the chamber 220 may be made of an opaque black thermoplastic material, an opaque thermoset material or a metal. The cooking appliance of the present invention may further include a heating element relay 222 to control the electric resistance heating elements which heat the cooking cavity 6, as well as a temperature sensor 224 located within the cooking cavity 6. The temperature sensor 224 senses the cavity temperature and provides that information to the microcontroller 200. This temperature information may then be displayed on the LCD display 212 and/or used to complete one or more algorithms (for example, a temperature control algorithm) during operation of the appliance 1. Other types of user interface may be used to signal the user besides an LCD display, such as an LED display, or indicator lamps.

The undercabinet cooking appliance 1 in accordance with the invention includes a built-in smoke detection module 226. The smoke detection module 226 includes an energy source 228 for transmitting visual light or infrared energy into the smoke detection chamber 220, and a detector unit 230 with a corresponding detection circuit 232 for detecting any visual light or infrared energy which is scattered toward the detector unit 230. The energy source 228 is preferably a standard, inexpensive incandescent bulb (for example, a CMD2182 14V long life bulb manufactured by Chicago Miniature Lamp Co.) which emits both visual light as well as infrared radiation. The detector unit 230 may be a standard semiconductor photodiode or phototransistor (for example, a QSD122 phototransistor from QT Optoelectronics or Fairchild Semiconductor).

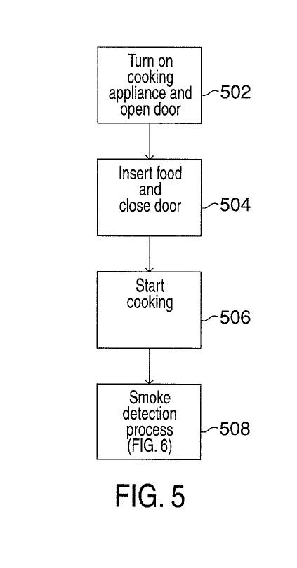

FIG. 3 shows a detailed schematic internal view of one side of the smoke detection module 226 of FIG. 2 in accordance with the invention. For purposes of reference only, the side of the smoke detection chamber 220 illustrated in FIG. 3 will be referred to as the right side. The opposing or left side of the chamber 220 is a substantial mirror image of the right side. As illustrated in FIG. 4, the left and right sides of the chamber 220 are securely sealed together to create a light-tight cavity within the chamber 220. Each edge 402 of the chamber 220 may include baffled ridges 404, which may further enhance the light-tight characteristic of the chamber 220. The external portion of each side of the chamber 220 may include mounting brackets 406 for mounting the smoke detection module 226 at an appropriate location within the cooking appliance 1.

Returning to FIG. 3, the energy source 228 and the detector unit 230 are preferably located at two adjacent corners of the smoke detection chamber 220 in respective independent venting channels 300, 302 within the chamber 220, and are respectively arranged to be directed at substantially right angles from each other. The energy source 228 is connected to the microcontroller 200, and the detector 230 is connected to the detection circuit 232 which in turn communicates with the microcontroller 200. As would be understood to those skilled in the art, a separate dedicated controller or control circuit could be used in place of microcontroller 200 to allow this device to be retrofitted into an existing kitchen appliance. In addition, an analog control circuit could be used to process alarm conditions and perform functions outlined herein. In order to more effectively exclude ambient light from the chamber 220 while allowing communication with the microcontroller 200 and the detection circuit 232, the corners at which the energy source 228 and detector unit 230 are located may be sealed with light seals 306. The light seals 306 include one or more apertures 308 through which wire connections may travel to allow communication with the microcontroller 200 and the detection circuit 232, respectively.

The venting channels 300, 302 are preferably arranged at right angles from each other, as illustrated, and intersect at a chamber cavity 304 substantially in the center of the chamber 220. One venting channel 300 may include an exhaust exit and drain hole 310 at one end, and the other venting channel 302 may include a smaller drain hole 312. In addition, one channel ends in an air aperature 316 for receiving air from the cooking cavity 6. In one embodiment of the invention, the smoke detection module 226 is arranged such that the electronic components are on the upper side of the chamber 220, and the drain holes 310, 312 are on the bottom side so that any moisture which may condense on the components inside the module 226 may escape from the drain holes 310, 312 with the help of gravity. Further, the module 226 itself is preferably located far enough away from the main circuit board (which typically contains the microcontroller and other circuitry) so as to prevent corrosive or other damaging liquids from dripping onto the board. The module 226 is also located so that exhausted smoke does not condense on the main circuit board, which could also result in damaging or corrosive deposits. A detailed method of operation of the smoke detection module 226 is described below with respect to FIG. 6.

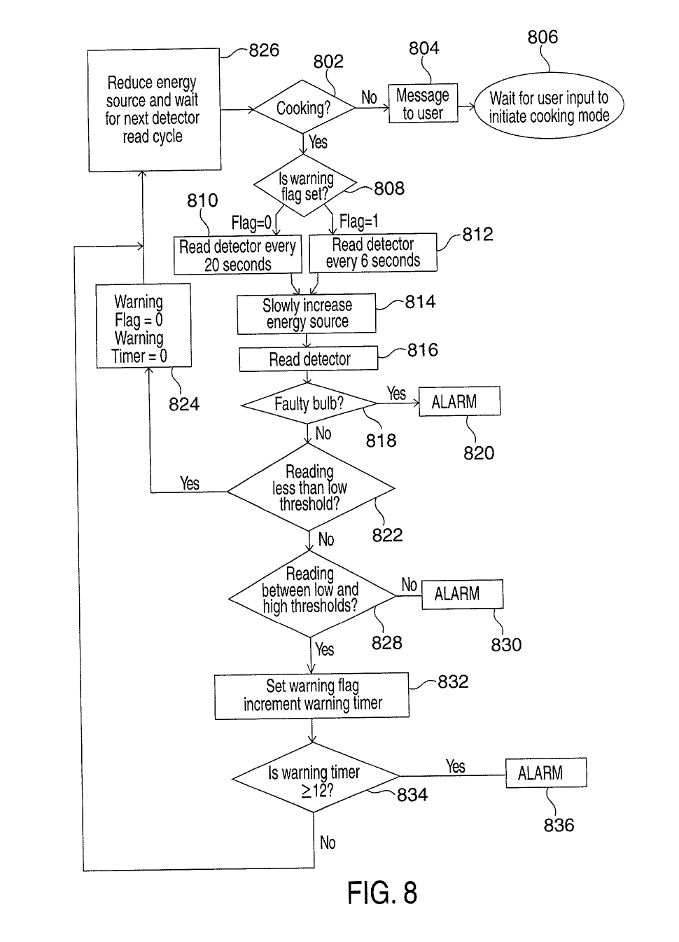

FIG. 7 illustrates a side cutaway view of the cooking appliance 1 illustrated in FIG. 1. In particular, FIG. 7 illustrates the relative location of various components of the control system of the appliance 1 in accordance with one embodiment of the invention. As illustrated, the user interface control panel 4 is located at the front of the appliance 1 so that a user may easily view and access the LCD display, and the visual indicators and interface buttons or controls 8. The fan 5 may be located on one side of the appliance 1 and functions to both create a convection air current within the cooking cavity 6 of the appliance 1, as well as to draw out air from inside the cooking cavity 6 and force it into the detection module 226. Additionally, this fan may have an extra set of fan blades (not shown) that draws ambient room air into the controls cavity of the oven, cooling it and removing exhausted smoke from said cavity. Air from the cooking cavity 6 may be forced into the module 226 through a smoke tube 704 connected to the detection module 226 via the air aperture 316. As further illustrated in FIG. 7 (and briefly explained above), the detection module 226 is located off of the main circuit board 706 (on which most of the other control components are located) so as to prevent corrosive or other damaging liquids from dripping onto the board, and connected to appropriate components on the main circuit board 706.

FIG. 5 illustrates a general method of operation of an undercabinet cooking appliance 1 as illustrated in FIG. 1. When the appliance 1 is powered off, the energy source 228 remains energized at a low “standby” level (for example, 5% of maximum). This increases the lifetime of the source 228 by keeping it warm and thus reducing stress on the filament when the intensity of the source 228 increases. To use the appliance 1, a user turns on the appliance 1 and the door 3 is opened (step 502). In one embodiment, the user instructs the automatic door 3 to open via the user interface control panel 4 (for example, the user may press a key called “door open/close” to open the door). In another embodiment, the door 3 may open automatically when the device is turned on. In a preferred embodiment, there is no handle to allow a user to manually open the door 3. This is advantageous from a safety standpoint, as it prevents a user from accidentally or unintentionally opening the door 3 in an alarm or emergency condition. A door locking mechanism could be used, but is not needed in the preferred embodiment because the door motor will not allow the door to be opened manually. An alarm or emergency condition is typically a situation when either smoke or fire has been detected within the cooking cavity 6. Alarm tasks associated with an alarm or emergency condition are discussed in detail below.

Once the door 3 is open, the user places a food item into the cooking cavity 6 and closes the door 3 (step 504). Similar to opening the door, the door may be closed by an instruction from the user via the user interface control panel 4. Alternatively, the door may be manually closed by the user. Then, a user may input one or more selectable settings into the user interface control panel 4, and then instruct the appliance 4 (via, for example, a “Start Cooking” button on the control panel 4) to beginning cooking. The selectable settings may include, for example, temperatures, time and/or cooking mode. Once cooking begins, the smoke detector module carries out a continuous smoke detection process (step 508) as described in detail with respect to FIG. 5. Alternatively, the smoke detection process may occur immediately upon powering on the appliance (step 502), and continue until the appliance is completely powered off.

FIG. 6 illustrates a method of detecting the presence of smoke in the cooking appliance 1 of FIG. 1 in accordance with the invention. Generally, the smoke detection module 226 receives air 218 from inside the cooking cavity 6 at regular intervals, either by being forced by a convection fan 5 or by natural convection. As explained further below, the module 226 generally operates by periodically illuminating or energizing the energy source 228 and obtaining one or more measurements from the detector unit 230 to determine the level (if any) of smoke present in the chamber cavity 304 of the chamber 220. When the energy source is energized, a beam of light shines into the light-tight chamber. As explained, the chamber is arranged such that air from the cooking cavity 6 (and thus smoke if present) enters the chamber and exits through a series of bends and elbows, (shown by, for example, the venting channels 300, 302 of FIG. 3), in the module that lock out excess ambient light. The beam of light and the reception angle of the detector unit 230 are at right angles from each other, such that normally almost no light is sensed by detector unit 230. If smoke is introduced into the chamber cavity 304, however, the beam of light reflects off of the smoke particles and some of the reflected light will fall on the detector unit 230, indicating a relative level of smoke in the cooking chamber 220.

The undercabinet cooking appliance 1 generally has four predetermined threshold values—three smoke detection thresholds (low, mid and high thresholds) and a faulty source threshold. These thresholds, which may be measured in units of “volts,” specifically indicate the level of reflectivity of energy (e.g., light, heat) in the chamber cavity 304. Because this reflectivity is proportional to the smoke levels detected, the thresholds (as well as the detection readings, which are discussed further below) will be identified in terms of smoke levels. Of course, more or less than four predetermined detection thresholds could be used in an alternative embodiment.

With respect to the faulty source threshold, either when the system is first turned on, when cooking begins, or on a continuous basis, the detector unit 230 obtains an initial detection reading (as described below) of scattered light. Even with no smoke at all, there still exists a minimal amount of scattering that may be detected by the detector unit 230. Thus, if the amount of light detected is less than the faulty source threshold when the unit is turned on or cooking just begins, then either the bulb has failed or become occluded with soot or cooking products. In either case, the microcontroller 200 shuts down operation of the toaster and alerts the user that there is a problem.

As illustrated in FIG. 6, the intensity level of the energy source 228 is first slowly increased from the low-level standby intensity (for example, 5%) to maximum (i.e., 100%) intensity (step 602). This increase may occur, for example, over the course of 230 milliseconds. Alternatively, the intensity could be immediately increased from a low level to maximum. Then, at the start of cooking (or, in the alternative, when the appliance 1 is powered on), the system determines whether the energy source is faulty (step 604) by obtaining a detection reading. In one embodiment, a detection reading may be obtained by taking a predetermined number of measurements of energy detected by the detector unit 230 (for example, seven measurements) at predetermined time intervals (e.g., every 2300 microseconds), and calculating either the median or the average of these seven measurements. One reason for taking multiple measurements is to filter out unwanted noise. Alternatively, an analog or digital filter may be used to filter noise components and process the measurements. This median or average calculation is referred to herein as a “detection reading” by the detector unit. At the end of each detection reading, the energy level of the source 228 may be slowly reduced from 100% to some lower level (for example, 5%) to conserve longevity of the source 228, until the next detection reading, at which time the intensity level is again slowly increased to 100%. If the detection reading indicates a detection of energy less than the faulty source threshold, this indicates a faulty source. If a faulty source is detected, an alarm condition is identified (step 606), and one or more alarm tasks (as discussed below) are carried out.

In one embodiment, once it is determined that the energy source is not faulty (step 604), it may be determined whether the appliance 1 is in a cooking mode (step 608). If not (for example, cooking is complete or the user turned off the heating elements), the appliance 1 may provide some message to the user such as “Cooking Complete” or “Cooking terminated,” and may slowly reduce the intensity level of the energy source back to the standby level (e.g., 5%) (step 612). This determination of whether the appliance is in a cooking mode (step 608) may occur continually in the background of the detection process, or may only occur at designated times.

After a faulty source determination is made (step 604), smoke detection takes place by obtaining detection readings at various predetermined time intervals. Initially, a detection reading may be obtained once every 20 seconds (step 614). At each of these intervals, the system determines whether the current calculated detection reading is below the low threshold (step 616). For example, the low threshold may be 1.27 volts. If the detection reading is below 1.27 volts, then the next detection reading is taken 20 seconds later.

If the detection reading is neither less than 1.27 volts nor between the low threshold (1.27 volts) and the high threshold (for example, 1.76 volts) (step 618), this means the detection reading is above the high threshold, which indicates a likely problem. In this case, an alarm condition is identified (step 620), and one or more alarm tasks (as discussed below) are carried out. However, if the detection reading is between the low and high thresholds (referred to as the “mid-level detection range”), a warning flag is set to indicate that the smoke level is in this mid-level detection range, and a warning timer is set to zero (step 622). For purposes of this discussion, a value of “1” for the warning flag indicates smoke levels in the mid-level detection range, and a value of “0” indicates smoke levels above or below the mid-level detection range.

Setting of the warning flag to “1” triggers the smoke detector to be read more often, such as every 6 seconds rather than every 20 seconds (step 624). In many circumstances where the most recent detection reading is greater than the low threshold, but not as high as the high threshold, an alarm condition may not actually exist. Thus, the increased frequency in detection readings is first done in this mid-level detection range to more closely monitor the situation and be ready to indicate an alarm condition should the situation turn into one. For example, through testing, the inventor has determined that when most foods product smoke levels of 1.27 volts or greater, they are generally already too burnt to be edible, but have not produced dangerous amounts of flame or smoke. Performance of the increased frequency of detection readings in the mid-level detection range as described herein makes the device less sensitive to quick puffs of smoke (such as may occur, for example, if juices from the cooking food drip onto a heating element), and more sensitive to a sustained stream of smoke which may be of a somewhat lower-level than an immediate alarm condition, but that may nevertheless indicate a problem. Thus, the step of increasing the detection interval (step 624) reduces the occurrence of a false alarm condition or a missed alarm condition.

While the smoke level is between the mid-level detection range (which is, as explained above, when the smoke level is between the low threshold and the high threshold, and thus the warning flag=1), the step of determining whether the appliance 1 is still in a cooking mode (step 608) may occur again as explained above (step 608). As explained, while the warning flag=1, the system obtains a detection reading every 6 seconds. For each detection reading taken while the warning flag=1, it is determined whether the smoke level for that detection reading is greater than the low threshold (e.g., greater than 1.27 volts). If not, the warning flag is reset to “0” (step 610), and thus the detection reading interval returns to one detection reading every 20 seconds. However, if the detection reading indicates a smoke level greater than the low threshold, it is determined if the detection reading is less than the mid threshold (for example, 1.57 volts) (step 628). If the smoke level is between the low and mid thresholds, the warning flag remains set at 1 and the warning timer is reset to zero (or remains zero if the timer was never started) (step 622). However, if the smoke level is greater than the mid threshold, it is determined whether the level is less than the high threshold (step 630).

If the smoke level is not less than the high threshold (i.e., it is greater than the high threshold), an alarm condition is identified (step 632), and one or more alarm tasks (as discussed below) are carried out. However, if it is determined that the smoke level is less than the high threshold (and thus between the mid and high thresholds), it is determined if the warning timer is equal to 0 (step 634). If it is, the warning timer begins to run, and a new detection reading is taken six seconds after the prior detection reading (step 624). If the warning timer is not equal to zero, then it is determined if the warning timer is greater than or equal to a predetermined time (for example, 12 seconds). If the timer is not greater than or equal to 12 seconds, the next detection reading is taken six seconds after the prior detection reading (step 624). However, if the warning timer is greater than or equal to 12 seconds, this indicates that the smoke level has remained above the mid level (but below the high level) for at least 12 seconds, and thus an alarm condition is identified (step 640), and one or more alarm tasks (as discussed below) are carried out.

In the flow chart illustrated in FIG. 6, it is noted that with respect to the detection reading steps (step 614 and 624), the process preferably continues to the steps following these detection reading steps automatically and continuously, even if a new detection reading has not been taken, so that the timing determinations (for example, step 638) are made in a timely fashion.

When an alarm condition is identified (for example, steps 606, 620, 632 and 640), this generally means that either smoke or a fire has been detected within the cooking cavity 6, and thus one or more alarm tasks associated with the alarm condition should be carried out to contain the smoke and/or fire, and to otherwise maintain the safety of the user as well as the surfaces surrounding the appliance 1. The alarm tasks may include automatically closing the electronic door 3 and rendering it inoperable, thus containing the smoke and/or fire within the cooking chamber. This is a helpful safety feature of the system because it is highly unlikely that a smoking or ignited food item in the heating cavity 6 will ignite any surrounding surfaces through the metal walls of the cooking appliance 1.

The alarm tasks may also include shutting off or de-energizing the heating elements of the cooking appliance 1. If the cooking chamber is kept closed in combination with the heating elements being de-energized, there is little to no chance for flame to escape the cooking cavity 6 and cause damage to outside surfaces. The alarm tasks may further include activation of an aural or visual indication (or some other message) to alert the user that there is a problem. This indication may further include a text message indicating exactly what the problem is which has occurred.

FIG. 8 illustrates an alternative method of detecting smoke and alarm conditions in the undercabinet cooking appliance of FIG. 1. As many of the steps are similar to those described with respect to FIG. 6, the alternative method of FIG. 8 will only be briefly described herein. First it is determined whether the appliance 1 is in a cooking mode (step 802). If it is not, then an appropriate message is provided to the user via, for example, an audio tone, a visual indicator or a text message (on the LCD) (step 804). The appliance 1 then waits for a user input to initiate cooking (step 806). If the appliance 1 is in a cooking mode, then a warning flag is checked to determine if it is set to 1 or 0 (step 808). It is noted that the warning flag and warning timer are initially, upon powering on the appliance, set to zero. If the warning flag is set to 0, then detection readings are taken every 20 seconds (or some other predetermined interval of time) (step 810). If the warning flag is set to 1, then detection readings are taken every 6 seconds (or some other predetermined interval of time which is less than the interval of time for detection readings when the warning flag is set to 0) (step 812). It is understood by one of skill in the art that the warning flag values may be reversed.

For each detection reading the energy source is slowly increased from a less than maximum intensity level (for example, 5%) to maximum intensity (step 814). A detection reading is obtained (step 816) and a determination is made as to whether the energy source is faulty (step 818). If the energy source is faulty, an alarm condition is identified (step 820), and one or more alarm tasks (as discussed above) are carried out. If the energy source is not faulty, then it is determined whether the obtained detection reading is at a value less than the low threshold (step 822), and if it is, the warning flag and warning timer are reset to 0 (step 824). However, if the obtained detection reading is not less than the low threshold, it is determined whether the obtained detection reading is at a value between the low and high thresholds (step 828). If the obtained detection reading is not between the low and high thresholds (and also not less than the low threshold as determined at step 822), then it is above the high threshold. Thus, an alarm condition is identified (step 830), and one or more alarm tasks (as discussed above) are carried out.

If the detection reading is between the low and high thresholds as determined at step 828, then the warning flag is set to 1 and the warning timer begins to run (or continues to run if the warning flag was already previously set to 1). In one embodiment, the warning timer is only reset to zero when the warning flag is reset to zero. Next, it is determined whether the warning timer is greater than or equal to 12 seconds (or some other predetermined time period), and if it is, an alarm condition is identified (step 836), and one or more alarm tasks (as discussed above) are carried out. If the warning timer is less than 12 seconds, the intensity of the energy source is slowly reduced and the controls wait for the next detection reading (based on the value of the warning flag) (step 826).

While various embodiments of the application have been described, it will be apparent to those of ordinary skill in the art that many more embodiments and implementations are possible that are within the scope of this invention. For example, one of ordinary skill in the art would understand that the scope of this invention includes an independent smoke detection module which may be retrofitted into an existing or stand alone cooking appliance as a separate component therefor. Such an independent smoke detection module may include its own power supply, controller, audio transducer and/or visual transducer or display, and may be used to detect smoke in a cooking appliance while operating independently of most or all controls of the cooking appliance. Accordingly, the invention is not to be restricted except in light of the attached claims and their equivalents.

What is claimed:

1. A cooking appliance comprising:
a housing with a heating cavity;
a door;
a heating element;
a controller; and
a detection module, said detection module comprising:
an energy source directing energy toward a first direction, and in communication with the controller;
a detector unit receiving energy from a second direction substantially perpendicular to said first direction, and in communication with the controller;
an aperture for allowing entrance of air into the detection module from the cooking appliance; and
one or more drain holes oriented such that condensation does not fall on the energy source or the detector unit;
wherein the detector unit detects a level of smoke in the air from the cavity of the cooking appliance based on an amount of energy scattered from said first direction toward the second direction, and an alarm condition is identified based on said level of smoke.

2. The cooking appliance of claim 1 wherein the detection module is located at a position with the cooking appliance such that any substance escaping from the detection module avoids contact with the controller.

3. A cooking appliance comprising:
a housing with a heating cavity;
a door;
a heating element;
a controller; and
a detection module, said detection module comprising:
an incandescent bulb directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on said level of smoke.

4. A cooking appliance comprising:
a housing with a heating cavity;
a door;
a heating element;
a controller; and
a detection module, said detection module comprising:
an energy source continuously energized at a level of 5% or greater of the maximum intensity level, directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on said level of smoke.

5. A cooking appliance comprising:
a housing with a heating cavity;
a door;
a heating element;
a controller; and
a detection module, said detection module comprising:
an energy source directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on the amount of light scattered from said energy source being at a level relative to one or more smoke detection thresholds.

6. The cooking appliance of claim 5 wherein the detector unit detects a faulty energy source based on the amount of light scattered from said energy source being at a level relative to a faulty source threshold.

7. A cooking appliance comprising:
a housing with a heating cavity;
a door;
a heating element;
a controller; and
a detection module, said detection module comprising:
an energy source directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on said level of smoke;
wherein the door of the cooking appliance is rendered inoperable upon identification of the alarm condition.

8. The cooking appliance of claim 7 wherein a heating element of the cooking appliance is de-energized upon identification of the alarm condition.

9. A cooking appliance comprising:
a housing with a heating cavity;
a door;
a heating element;
a controller; and
a detection module, said detection module comprising:
an energy source directing energy toward a first direction, and in communication with the controller;
a detector unit receiving energy from a second direction substantially perpendicular to said first direction, and in communication with the controller;
an aperture for allowing entrance of air into the detection module from the cooking appliance; and
one or more venting channels;
wherein the detector unit detects a level of smoke in the air from the cavity of the cooking appliance based on an amount of energy scattered from said first direction toward the second direction, and an alarm condition is identified based on said level of smoke.

10. A method of detecting an alarm condition in a cooking appliance comprising:
obtaining detection readings at predetermined intervals of time corresponding to an amount of scattered light in a detection module;
comparing the obtained detection reading to a first smoke detection threshold and a second smoke detection threshold;
determining whether an alarm condition exists based on said comparisons; and
decreasing said intervals of time if an obtained detection reading is between said first and said second smoke detection thresholds.

11. The method of claim 10 further comprising determining that an alarm condition exists if sequentially obtained detection readings remain between said first and said second smoke detection thresholds for a predetermined period of time, and increasing said intervals of time if sequentially obtained detection readings do not remain between said first and said second smoke detection thresholds for said predetermined period of time.

12. The method of claim 10 further comprising determining that an alarm condition exists if an obtained detection reading is less than a faulty source threshold.

13. The method of claim 10 further comprising rendering a door of the cooking appliance inoperable upon determining that an alarm condition exists.

14. The method of claim 10 further comprising de-energizing a heating element of the cooking appliance upon determining that an alarm condition exists.

15. A detection module for use in a cooking appliance, said detection module comprising:
an energy source directing energy toward a first direction, and in communication with the controller;
a detector unit receiving energy from a second direction substantially perpendicular to said first direction, and in communication with the controller;
an aperture for allowing entrance of air into the detection module from the cooking appliance; and
one or more drain holes oriented such that condensation does not fall on the energy source or the detector unit;
wherein the detector unit detects a level of smoke in the air from the cavity of the cooking appliance based on an amount of energy scattered from said first direction toward the second direction, and an alarm condition is identified based on said level of smoke.

16. A detection module for use in a cooking appliance, said detection module comprising:
an energy source directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein said detection module is located at a position with the cooking appliance such that any substance escaping from the detection module avoids contact with the controller; and
the detector unit detects a level of smoke in the air from the cavity of the cooking appliance based on an amount of energy scattered from said first direction toward the second direction, and an alarm condition is identified based on said level of smoke.

17. A detection module for use in a cooking appliance, said detection module comprising:
an incandescent bulb directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on said level of smoke.

18. A detection module for use in a cooking appliance, said detection module comprising:
an energy source continuously energized at a level of 5% or greater of the maximum intensity level directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on said level of smoke.

19. A detection module for use in a cooking appliance, said detection module comprising:
an energy source directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on the amount of light scattered from said energy source being at a level relative to one or more smoke detection thresholds.

20. The detection module of claim 19 wherein the detector unit detects a faulty energy source based on the amount of light scattered from said energy source being at a level relative to a faulty source threshold.

21. A detection module for use in a cooking appliance, said detection module comprising:
an energy source directing energy toward a first direction, and in communication with the controller;
a detector unit receiving energy from a second direction substantially perpendicular to said first direction, and in communication with the controller; and
an aperture for allowing entrance of air into the detection module from the cooking appliance;
wherein the detector unit detects a level of smoke in the air from the cavity of the cooking appliance based on an amount of energy scattered from said first direction toward the second direction, and an alarm condition is identified based on said level of smoke; and
wherein the door of the undercabinet cooking appliance is rendered inoperable upon identification of the alarm condition.

22. The detection module of claim 21 wherein a heating element of the cooking appliance is de-energized upon identification of the alarm condition.

23. A detection module for use in a cooking appliance, said detection module comprising:
an energy source directing energy toward a first direction, and in communication with the controller;
a detector unit receiving energy from a second direction substantially perpendicular to said first direction, and in communication with the controller;
an aperture for allowing entrance of air into the detection module from the cooking appliance; and
one or more venting channels;
wherein the detector unit detects a level of smoke in the air from the cavity of the cooking appliance based on an amount of energy scattered from said first direction toward the second direction, and an alarm condition is identified based on said level of smoke.
